(19) United States
(12) Patent Application Publication
(10) Pub. No.: US 2014/0330597 A1
(43) Pub. Date: Nov. 6, 2014

(54) TICKET TRANSACTION AND PRICING SYSTEM

(71) Applicant: Gametime, San Francisco, CA (US)

(72) Inventor: Brad Griffith, San Francisco, CA (US)

(73) Assignee: Gametime, San Francisco, CA (US)

(21) Appl. No.: 14/179,536

(22) Filed: Feb. 12, 2014

Related U.S. Application Data
(60) Provisional application No. 61/763,726, filed on Feb. 12, 2013.
(60) Provisional application No. 61/892,394, filed on Oct. 17, 2013.

(51) Int. Cl. G06Q 10/02

(52) U.S. Cl. CPC G06Q 10/02
USPC 705/5

(57) ABSTRACT

A ticket transfer system includes a ticket analyzer system includes logic adapted to receive an image of a ticket to an event. The ticket analyzer system includes logic adapted to extract information about the ticket from the image. The ticket analyzer includes logic adapted to apply the extracted information to identify a primary market system for the ticket and to verify validity of the ticket with the primary market system. The ticket analyzer system includes logic adapted to apply received signals on weather, time, and crowd conditions for the event to affect a price displayed for the ticket on an online exchange.

### PRIORITY AND CROSS REFERENCE TO RELATED APPLICATIONS

This application claims priority and benefit under 35 U.S.C. 119 to U.S. application Ser. No. 61/763,726, filed on Feb. 12, 2013, which is incorporated herein by reference in its entirety. This application claims priority and benefit under 35 U.S.C. 119 to U.S. application Ser. No. 61/892,394, filed on Oct. 17, 2013, which is incorporated herein by reference in its entirety.

### BACKGROUND

Many events utilize paper tickets distributed to people who will be granted access to the events. Paper tickets are efficient and lightweight credentials which can authenticate a person for entry. However, paper tickets are inconvenient to transfer to others as the time of the event grows nearer. The tickets must either be handed off in person, or mailed, both of which involve coordination and timing. Sometimes, the event is so imminent that it is not possible to sell or otherwise transfer a paper ticket, except by getting as close as physically allowed to the event and “scalping” the ticket to someone. A more efficient mechanism for transferring paper tickets near event time is therefore desirable.

People with one or more tickets to an event (e.g., a sporting match) may have unused tickets available. This may present an opportunity for buyers, especially late buyers, who want tickets.

Online ticket markets are available (e.g., Stubhub™), but these require the ticket holder to be knowledgeable about price trends, and to invest time-intensive monitoring to secure an optimal price. Online services usually involve account setup and manual data entry related to the potential transaction/tickets.

Tickets have perishable value and the above constraints lead to situations where tickets go unsold and unused. Ticket owners lose sales, and event venues lose ancillary revenues (e.g., concessions).

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a system diagram of an embodiment of a ticket transaction and pricing system.

FIG. 2 is an action flow diagram of an embodiment of a ticket transaction and pricing system.

FIG. 3 is a flow chart of an embodiment of a ticket transaction and pricing system.

FIG. 4 is a system diagram of an embodiment of a ticket transaction and pricing system.

FIG. 5 is an action flow diagram of an embodiment of a ticket transaction and pricing system.

FIG. 6 is a flow chart of an embodiment of a ticket transaction and pricing system.

FIG. 7 is a system diagram of an embodiment of a ticket transaction and pricing system.

FIG. 8 is an action flow diagram of an embodiment of a ticket transaction and pricing system.

FIG. 9 is a flow chart of an embodiment of a ticket transaction and pricing system.

FIG. 10 is a system diagram of an embodiment of a ticket transaction and pricing system.

FIG. 11 is an action flow diagram of an embodiment of a ticket transaction and pricing system.

FIG. 12 is a flow chart of an embodiment of a ticket transaction and pricing system.

FIG. 13 is a system diagram of an embodiment of a ticket transaction and pricing system.

FIG. 14 is an action flow diagram of an embodiment of a ticket transaction and pricing system.

FIG. 15 is a flow chart of an embodiment of a ticket transaction and pricing system.

FIG. 16 is a system diagram of an embodiment of a ticket transaction and pricing system.

FIG. 17 is an action flow diagram of an embodiment of a ticket transaction and pricing system.

FIG. 18 is a flow chart of an embodiment of a ticket transaction and pricing system.

FIG. 19 illustrates an embodiment a machine system to implement a ticket pricing system.

FIG. 20 illustrates an embodiment of a mobile device 2000 that may implement a machine having features described herein, for example a client device.

FIG. 21 illustrates an embodiment of a computer system machine and a machine communication network.

FIG. 22 illustrates an embodiment of a machine network to implement a ticket transaction and pricing system.

### DETAILED DESCRIPTION

Preliminaries

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other.

“Logic” refers to machine memory circuits, machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein.

The techniques and procedures described herein may be implemented via logic distributed in one or more computing devices. The particular distribution and choice of logic is a design decision that will vary according to implementation.

A system is described that allows ticket holder to sell, donate, gift or otherwise transfer ownership of one or more tickets to an event with a single action/interaction. The system does not incur delays for identifying a matching buyer. This system removes the need for the seller to set a price and monitor for bids. The system shifts economic surplus in the ticket market toward the ticket seller. Ticket information may be submitted to the system as photos, screen-shots (screen buffer scrapes), or directly in some other format such as XML.

‘sensor’ in this context refers to a device or composition of matter that responds to a physical stimulus (as heat, light, sound, pressure, magnetism, or a particular motion) and transmits a resulting impulse (as for measurement or operating a control).

‘machine interface’ in this context refers to one or more sensors coupled to machine logic such that signals generated by the sensors in response to physical events influence the logic and thus the actions of the machine.

‘signal’ in this context refers to one or more energy impulses that convey control commands, data, or attributes between machine elements or between people, or a combination of machines and people. Any physical entity exhibiting variation in time or variation in space is potentially a signal. Examples of signals are electrical impulses such as analog or binary electrical phenomenon, audio, video, speech, image, communication, geophysical, sonar, radar, and musical signals.

‘mobile device’ refers to a machine that is portable by a human operator and which communicates with other machines using one or more wireless signaling circuits (often in the radio frequency or optical frequency range).

‘camera’ in this context refers to a device that records images and/or video, either as analog or as digital information signals.

‘image’ in this context refers to information captured and stored by a device representing a visual perception, usually a two-dimensional picture. Images may be captured, stored, and communicated by devices in either analog or digital formats. Digital photos are an example of images, as are screen captures (e.g., reading and storing the contents of a machine display buffer, or ‘screen scraping’).

‘video’ in this context refers to information captured and stored by a device representing a sequence of moving pictures. Video may be captured, stored, and communicated by devices in either analog or digital formats.

‘client device’ refers to a device that operates in the role of a client in a client-server machine communication system.

‘clock’ refers to a machine that generates a timebase which can be accumulated and translated into an indication of a time, date, or both. ‘GPS’ in this context refers to (Global Positioning System) a space-based satellite navigation system that provides location and time information in most weather conditions, anywhere on or near the Earth where there is an unobstructed line of sight to four or more GPS satellites. The system provides critical capabilities to military, civil and commercial users around the world. It is maintained by the United States government and is freely accessible to anyone with a GPS receiver.

‘image’ in this context refers to information captured and stored by a device representing a visual perception, usually a two-dimensional picture. Images may be captured by cameras or ‘scraped’ from machine display memories. Images may be captured, stored, and communicated by devices in either analog or digital formats.

### Additional Terminology

(analog) in this context refers to information encoded in a continuously varying (non quantized or nondiscrete) signal. A continuously variable wave is an example of an analog signal. For example, in the case of wireless phones, analog transmission is where the sound waves of a person's voice are converted directly to specific, continuously-variable characteristics of a radio wave, and vice-versa. Analog signaling is being replaced by digital signaling in most machines and machine networks.

(antenna) in this context refers to a physical device that facilitates the transmission and reception of radio waves. Older phones used external antennas while most current phones use an internal antenna. The size and shape of the antenna is designed according to the type of radio waves being used. Antennas are used in systems such as radio and television broadcasting, point-to-point radio communication, wireless LAN, mobile phones, radar, and spacecraft communication. Antennas come in a variety of shapes and sizes. Some wireless phones contain internal antennas, while others have antennas that extend above the phone. The size and shape of an antenna is carefully designed and tuned to the type of radio wave being transmitted and received.

(application program) in this context refers to an application.

(application server) in this context refers to logic that provides resources to execute applications and makes features of those applications available to client devices over a network communication channel.

(application) in this context refers to logic that can be independently installed, accessed, and removed from a device, and which executes at lower permission levels and within confines as to functionality and device resource utilization as determined by operating system software. Often referred to as “regular” application logic, as opposed to driver, applet, or system logic; also, logic that causes a computer to perform tasks beyond the basic operation of the computer itself. The term “application” may be abbreviated in some contexts to simply “app”. An application may be logic built upon or integrated with operating system logic. Examples of application logic include enterprise software, accounting software, office suites, graphics software, games, web browsers, and media players. Applications may be bundled with the computer and its system software or published separately. Application logic applies the capabilities of a particular computing platform or system software to a particular purpose. Some applications are available in versions for several different platforms; others have narrower requirements and are thus called, for example, a Geography application for Windows or an Android application for education or Linux gaming.

(ASIC) in this context refers to Application-specific integrated circuit.

(audio) in this context refers to a representation of sound within a device or a physical storage or communication media, typically as either analog or digital signals.

(baseband) in this context refers to The original band of frequencies produced by a transducer, such as a microphone, telegraph key, or other signal-initiating device, prior to initial modulation. In wireless voice, the sound frequencies of the voice, before it is encoded and transmitted.

(battery) in this context refers to a device comprising of one or more electrochemical cells (which may be referred to as ‘stages’) that convert stored chemical energy into electrical energy. In general, a battery is a chemical energy source. Rechargeable batteries are revitalized with a charger that usually needs to be plugged into a power source; such as, an electrical outlet or a car cigarette lighter for a recharge.

(BIOS) in this context refers to (Basic Input/Output System), also known as System BIOS, ROM BIOS or PC BIOS is a definition of an interface to input and output devices of a machine. The BIOS are typically initializes and tests the machine I/O components, and loads a bootloader or an operating system from a mass memory device. The BIOS additionally provides abstraction layer for the hardware, i.e. a consistent way for application programs and operating systems to interact with the keyboard, display, and other input/output devices. Variations in the system hardware are hidden by the BIOS from programs that use BIOS services instead of directly accessing the hardware. Many operating systems ignore the abstraction layer provided by the BIOS and access the hardware components directly. The Unified Extensible Firmware Interface (UEFI) is a specification that defines a software interface between an operating system and platform firmware. UEFI is meant to replace the Basic Input/Output System (BIOS) firmware interface.

(BlueTooth) in this context refers to logic for exchanging data over short distances (using short-wavelength radio transmissions in the ISM band from 2400-2480 MHz) from fixed and mobile devices, creating personal area networks (PANs) with high levels of security. Bluetooth is a wireless protocol for exchanging data over short distances from fixed and mobile devices, creating personal area networks. Standard IEEE 802.15.1, is a wireless technology standard for exchanging data over short distances (using short-wavelength radio transmissions in the ISM band from 2400-2480 MHz) from fixed and mobile devices, creating for example personal area networks with levels of security.

(bridge) in this context refers to logic to enable two or more communication networks, or two or more network segments, to create an aggregate network. Bridging is distinct from routing which allows the networks to communicate independently as separate networks. A network bridge is a network device that connects multiple network segments.

(browser) in this context refers to logic that is operated by a device to access content and logic provided by Internet sites over a machine network. Browser logic provides a human-friendly interface to locate, access, utilize, and display content and logic encoded by web sites or otherwise available from servers of a network (such as the Internet).

(bus) in this context refers to a collection of coordinated conductors through which data is transmitted from one part of a device to another.

(camera) in this context refers to a device that records images and/or video, either as analog or as digital information signals. (image) in this context refers to information captured and stored by a device representing a visual perception, usually a two-dimensional picture. Images may be captured, stored, and communicated by devices in either analog or digital formats.

(cellular network) in this context refers to (mobile network) logic implementing a radio network distributed over land areas called cells, each served by at least one fixed-location transceiver, known as a cell site or base station. In a cellular network, each cell uses a different set of frequencies from neighboring cells, to avoid interference and provide guaranteed bandwidth within each cell. When joined together these cells provide radio coverage over a wide geographic area. This enables a large number of portable transceivers (e.g., mobile phones, pagers, etc.) to communicate with each other and with fixed transceivers and telephones anywhere in the network, via base stations, even if some of the transceivers are moving through more than one cell during transmission.

(client device) in this context refers to any machine that interfaces to a machine network to obtain resources from one or more server systems.

(controller) in this context refers to a logic component that performs data or signal processing to produce output signals applied to control the operation of one or more other logic components. The controlled component(s) may be internal to or external to the machine that is or includes the controller. A controller may form a link between two parts of a data processing device (for example a memory controller that manages access to memory for a computer) or a controller on an external device that manages the operation of (and connection with) that device.

(CPU) in this context refers to (Central Processing Unit), an electronic circuit that operates as a main and general purpose execution component for device logic.

(database server) in this context refers to one or more server machines that provide storage and access (queries against) database(s) on behalf of client devices.

(database) in this context refers to an organized collection of data (states of matter representing values, symbols, or control signals to device logic), structured typically into tables that comprise ‘rows’ and ‘columns’, although this structure is not implemented in every case. One column of a table is often designated a ‘key’ for purposes of creating indexes to rapidly search the database.

(database) in this context refers to an organized collection of data (states of matter representing values, symbols, or control signals to device logic), structured typically into tables that comprise ‘rows’ and ‘columns’, although this structure is not implemented in every case. One column of a table is often designated a ‘key’ for purposes of creating indexes to rapidly search the database.

(display) in this context refers to A output device for visual information. Display technologies, esp. for mobile devices, may include CSTN, TFT, TFD or OLED. There are also types of touchscreen displays, e.g. capacitive and resistive.

(DSP) in this context refers to (Digital Signal Processor).

(FPGA) in this context refers to field programmable gate array.

(gateway) in this context refers to a network device that serves as an interface to another network. Within enterprises, the gateway routes traffic from an internal network (e.g., LAN) to a wide area network such as the Internet. In homes, the gateway may be provided by the ISP that connects the home to the Internet. In enterprises, the gateway node often acts as a proxy server and a firewall.

(hard disk) in this context refers to hard drive.

(HTML) in this context refers to HyperText Markup Language, a standard markup language used to define web pages on the Internet for viewing and interaction with web browsers

(image) in this context refers to information captured and stored by a device representing a visual perception, usually a two-dimensional picture. Images may be captured, stored, and communicated by devices in either analog or digital formats.

(infrared) in this context refers to (IR) a line-of-sight wireless technology that uses a beam of invisible light to transmit information. This means that the infrared ports of both devices must be nearby and aimed at each other for a connection to succeed. Infrared is the same technology used in most remote controls for home A/V gear such as TVs. Some smartphones are capable of controlling home A/V gear via infrared. Software that mimics a universal remote control is required, which may be included, or may need to be purchased from a third party and downloaded to the phone. In early smartphones, from 2001 to 2007, infrared was also used for two-way exchange of data between phones, or between phones and computers. The main standard for this was IrDA. This functionality was then replaced by Bluetooth, which uses radio waves instead of light. Bluetooth is faster, more reliable, and more versatile than IrDA.

(IP) in this context refers to (Internet Protocol) a primary protocol in the Internet protocol suite designed to enable delivery of data packets from a source device to a destination device based on an address (i.e., an IP address). IP defines datagram structures that encapsulate the data to be delivered. It also defines addressing mechanisms to identify the datagram source and destination devices. IP is protocol used for communicating data across a packet-switched network used in most publicly accessible networks today. Connections that mobile devices make to GPRS, 3G and similar networks are made using IP.

(keypad) in this context refers to a device including an arrangement of buttons or keys, to act as switches each associated with a symbol. Pressing or activating a key inputs the associated character to an attached device.

(LAN) in this context refers to logic implementing a network that interconnects computers and devices in a defined area such as a home, school, computer laboratory, or office building. LANs, in contrast to wide area networks (WANs), include usually higher data-transfer rates, smaller geographic area, and lack of a need for leased telecommunication lines. Ethernet over twisted pair cabling, and Wi-Fi (Wireless LANs, or WLANs) are two common technologies currently used to build LANs.

(load balance) in this context refers to load balancing.

(load balancing) in this context refers to a resource cluster and associated logic for distributing workloads across multiple components or communication links. Load balancing may attempt to optimize resource utilization in an even fashion, maximize throughput, minimize response time, and avoid overloads. Because it utilizes multiple components, load balancing may increase reliability through redundancy.

(memory) in this context refers to a device having a machine interface and storing data in the form of an altered material/energy configuration. Two common types of device memory are SAM, or Sequential Access Memory and RAM, or Random Access Memory. Data on SAM devices is read and written in a sequence, while data on a RAM device is read or written in any order. Examples of SAM devices include CD-ROMS and magnetic tape. RAM devices include flash drives and solid state hard drives. RAM is usually faster than SAM. Other examples of device memory are hard drives, flash drives, optical discs and RAM chips.

(microphone) in this context refers to Also, an acoustic-to-electric transducer or sensor that converts sound into an electrical signal. Many microphones use electromagnetic induction (dynamic microphone), capacitance change (condenser microphone), piezoelectric generation, or light modulation to produce an electrical voltage signal from mechanical vibration. A device that converts vibrations in a physical medium (e.g., air) into electromagnetic signals (e.g., electrical signals)

(mobile device) in this context refers to any device that includes logic to communicate over a machine network and having a form factor compatible with being carried conveniently by a single human operator. Mobile devices typically have wireless communications capability via WAPs or cellular networks.

(modem) in this context refers to (modulator-demodulator) a device that modulates a carrier signal to encode digital information, and also demodulates such a carrier signal to decode the transmitted information.

(OS) in this context refers to logic that manages device hardware resources and provides common services for application logic. The operating system is a component of many devices, such as computers and mobile phones. Application logic usually requires an operating system in order to function. Operating systems typically manage utilization of device resources, such as I/O devices, displays, processor utilization, memory, mass storage, and printing. The operating system acts as an intermediary between applications and the hardware resources, although applications are often (though not always, in the case of virtual machines) executed directly by the device hardware (e.g., one or more CPUs) and will frequently make system calls to the operating system, or be interrupted by it. Operating systems can be found on almost any device that contains a programmable processor or controller, from cellular phones and video game consoles to supercomputers and web servers.

(processor) in this context refers to any circuit or virtual circuit (a physical circuit emulated by logic executing on an actual processor) that manipulates data values according to control signals (e.g., ‘commands’, ‘op codes’, ‘machine code’, etc.) and which produces corresponding output signals that are applied to operate a machine.

(RAM) in this context refers to (Random-Access Memory) a type of memory that is fast relative to other (e.g., nonvolatile) memory is a device, but is volatile, meaning stored information is lost when electric power is removed. RAM is also typically freely addressable, meaning addressability is not constrained to block or sequential access. For these reasons, it is useful only for temporary storage of data that requires fast access. A device will typically have RAM and some kind non-volatile memory to store a copy of all logic (i.e., ‘code’ and ‘data’) that needs to be maintained when the device is powered off or that specific logic is not executing on the device. Both the OS and application software typically use RAM.

(RF) in this context refers to (radio frequency) a rate of oscillation in the range of about 3 kHz to 300 GHz, which corresponds to the frequency of electromagnetic radio waves, and the alternating currents which carry radio signals. RF usually refers to electrical rather than mechanical oscillations, although mechanical RF systems do exist. (Radio) can refer to anything related to radio signals, which are invisible electromagnetic waves created by applying a pulsing electric current to an antenna.

(ROM) in this context refers to device memory containing data that normally can only be read, not written to. Unlike a computer's random access memory (RAM), the data in ROM is not lost when the computer power is turned off. The data on the ROM can usually be loaded into the RAM if needed. “Read-only memory” may in fact be writable memory, but the process of writing data is comparatively slow and infrequent as compared to RAM, and often does not permit the addressing flexibility that RAM does.

(router) in this context refers to logic that distributes digital information that is contained within a data packet. Each data packet contains address information that a router can use to determine if the source and destination are on the same network, or if the data packet must be transferred from one network to another. This transfer to another type of network is achieved by encapsulating the data with network specific protocol header information. When multiple routers are used in a large collection of interconnected networks, the routers exchange information about target system addresses, so that each router can build up a table showing the preferred paths between any two systems on the interconnected networks.

(sensor) in this context refers to a device or composition of matter that responds to a physical stimulus (as heat, light, sound, pressure, magnetism, or a particular motion) and transmits a resulting impulse (as for measurement or operating a control)

(server) in this context refers to logic designed to respond to requests for functionality from client logic that interacts with the server logic via a request/response model, often over a network. Thus, the server performs some operation utilizing the underlying resources of the device or devices hosting the server, on behalf of clients (request submitters). The client logic either executes on the same device or devices as the server logic, or interacts with the server logic through a machine data network.

(speaker) in this context refers to an electroacoustic transducer that produces sound in response to an electrical or optical audio signal input; a device that converts signals output from a device into vibrations in a physical medium, usually the air.

(transducer) in this context refers to a device that converts a signal in one form of energy to another form of energy.[1] Energy types include (but are not limited to) electrical, mechanical, electromagnetic (including light), chemical, acoustic and thermal energy. While the term transducer commonly implies the use of a sensor/detector, any device which converts energy can be considered a transducer. Transducers are widely used in measuring instruments.

(USB) in this context refers to a standard for a wired connection between two electronic devices, including a mobile phone and a desktop computer. The connection is made by a cable that has a connector at either end. One end, the one that plugs into the computer, is the same across all USB cables while the one that plugs into the mobile device can be of various types such as miniUSB, microUSB or a proprietary connector. USB version 1.1 provides maximum speeds of up to 1.5 MB/s while the current version 2.0 is about 40 times faster. The versions are backwards compatible and the speed is limited by the slower device. Transferring data may require drivers to be installed on the desktop computer but some phones offer “mass storage” mode which means they appear as thumb drives to the computer and no special drivers are needed. In addition to their data transferring application, USB cables also carry an electric charge that can be used to power peripherals (such as USB mice or keyboards), and many mobile phones can be charged through their USB port. Universal Serial Bus (USB) is an industry standard developed in the mid-1990s that defines the cables, connectors and communications protocols used in a bus for connection, communication and power supply between computers and electronic devices, including mobile devices. USB was designed to standardize the connection of computer peripherals (including keyboards, pointing devices, digital cameras, printers, portable media players, disk drives and network adapters) to personal computers, both to communicate and to supply electric power. It has become commonplace on other devices, such as smartphones, PDAs and video game consoles. USB has effectively replaced a variety of earlier interfaces, such as serial and parallel ports, as well as separate power chargers for portable devices.

(video) in this context refers to information captured and stored by a device representing a sequence of moving pictures. Video may be captured, stored, and communicated by devices in either analog or digital formats. Also refers to recording, manipulating, and displaying moving images, especially in a format that can be presented on a television. Also refers to displaying images and text on a computer monitor or mobile device. The video adapter, for example, is responsible for sending signals to the display device. A recording produced with a video recorder (camcorder) or some other device that captures full motion.

(WAN) in this context refers to (Wide Area Network) a network that provides data communications to a larger number of users than are usually served by a local area network (LAN) and is usually spread over a larger geographic area than that of a LAN. Logic implementing a network that covers a broad area (e.g., a telecommunications network that links across metropolitan, regional, or national boundaries) using private or public network transports. Business and government entities utilize WANs to relay data among employees, clients, buyers, and suppliers from various geographical locations. The Internet can be considered a WAN.

(WAP) in this context refers to (wireless access point) a device that makes a wireless interface to a network available to client devices. Examples of wireless network access points are WiFi “hotspots” and 3G and 4G cellular hotspots wireless access point, a device or system including radio transceivers that convert digital information to and from radio signals that can be exchanged with other wireless communication devices. The most basic forms of wireless access points simply for wireless connections. A wireless access point that includes the ability of DHCP and network address translation (NAT) is typically called a wireless gateway.

(web server) in this context refers to a device or device system that delivers web pages in response to requests for the web pages from web browsers. Also, logic to communicate web pages at the request of clients, most typically using the Hypertext Transfer Protocol (HTTP). The server communicates HTML documents and any additional content that may be included by a document, such as images, style sheets and scripts, as well as content referenced by certain types of links (pointers) in the web pages. A user agent, commonly a web browser or web crawler, initiates communication with the web server by making a request for a resource using (typically) HTTP, and the server responds with the content of that resource or an error message if unable to do so. The resource is typically a file on the server's secondary storage, but this is not necessarily the case. Many web servers have a capability of receiving content from clients. This feature is used for submitting web forms, including uploading of files.

(WML) in this context refers to Wireless Markup Language, an industry-standard markup language for creating special, small web sites optimized for phones. WML was a core feature of the WAP 1.x standard. WML has generally been phased out in favor of the newer xHTML standard, part of WAP 2.0. Most phones support both WAP 1.x (WML and WAP 2.0 (XHTML). Older phones may only support WAP 1.x (WML) sites.

(XML) in this context refers to eXtensible Markup Language, a standard that forms the basis for most modern markup languages. XML is an extremely flexible format that only defines “ground rules” for other languages that define a format for structured data designed to be interpreted by software on devices. XML by itself is not a data format. Examples of XML-based standards include xHTML, for creating web pages, RSS, for feeds of new information (such as news headlines), and SyncML, for managing personal data such as contacts, email, files, and events.

### DESCRIPTION

Described herein are various components including logic to carry out actions described in conjunction with the description below. The logic to carry out these actions may be included in cell phones or other portable devices carried by people, and in server systems that are not mobile but which are accessible via communication channels such as the Internet.

Embodiments of a ticket transfer system are described that include a ticket analyzer system adapted to receive an image of a ticket to an event, to extract information about the ticket from the image, to apply the extracted information to identify a primary market system for the ticket and to verify validity of the ticket with the primary market system, and to apply received signals on weather, time, and crowd conditions for the event to affect a price displayed for the ticket on an online exchange. The ticket transfer system may apply received signals identifying locations of client devices of identified potential buyers of the ticket to affect the price displayed for the ticket. The ticket transfer system may apply received signals on bidding history for tickets having similar properties as the ticket to affect the displayed price. The ticket transfer system may apply received signals on bid velocity or bid acceleration for the ticket to the displayed price. The ticket transfer system may communicate signals defining a regenerated version of the ticket to a client device of a purchaser of the ticket.

Various example embodiments of a system to transfer rights associated with paper tickets from one party to another are described herein. In one embodiment, an image capture of a paper ticket is made (e.g., using a cell phone camera or screen scrape) and the image is provided to a server system for analysis. A server system is a computer system physically separated from the device that captured the image and which is communicatively coupled to the capture device by way of a network, typically by way of internet connection. Thus the server system will be accessed as a world wide web IP address, and/or Uniform Resource Locator.

The server analyzes the photo and provides a bar code or other identifying information from the analyzed photo to a ticketing service. A ticketing service provider is an on-line (Internet accessible) service which performs functions that include ticket sales or ticket entry right transfers (Stubhub.com is an example of an online ticket service). The bar code may be authenticated by the service provider, meaning that is confirmed to be a valid ticket identification. Authentication in this manner is not required in all embodiments. If the authentication fails, the capture device is notified of the failure. Otherwise, the capture device is notified that authentication is successful. A user action is enabled for the ticket, such as to donate it, to place it up for sale, or some other action that involves a transfer of ownership of rights in the ticket.

The action code is communicated to the server system, which communicates with the will-call office of the event that honors the ticket, meaning the place where people go to pick up entry tickets to the event at the time of the event or at some time before the event. The notification indicates that rights in the ticket have been transferred to a new party, and identifies that party to a ticket distributor or point of entry system (e.g., will-call). This could be initiated with an automatic phone call, with an email, a file transfer, Internet signal exchange, or with some other form of data communications.

A second embodiment of a ticket transfer will now be described. In this embodiment, image capture and analysis is made as before, and the ticket is authenticated in a manner similar to the manner already described. However, one difference is that a transcription service is accessed by the server system to confirm certain data on the ticket. The transcription service confirms that the ticket is in fact is readable. Thus the transcription service (utilizing machine OCR potentially augmented by human interpretation) may perform photo analysis of the ticket and provide identifying information (e.g. text and machine codes such as bar codes) back to the server system along with an indication that the ticket is readable. Once the ticket is authenticated, it is placed on market for purchase or transfer. If a purchase or transfer takes place, the ticket is regenerated, meaning the old ticket is invalidated and a new ticket is generated with a new bar code or other identifying unique code. A digital version of new ticket is provided to the purchasing person's portable device for scanning or other presentation at the entry point of the event.

In one embodiment, the client device (e.g. a cell phone of a new owner of the ticket) performs ticket regeneration, meaning generating a new ticket that will be honored at the event in place of the transacted ticket. The necessary information for regeneration is sent from the transaction system to a regeneration system or to the purchaser's portable device. Information for ticket regeneration may include a new barcode (or other unique ticket ID), section, row, seat, and other event information. The server system may invalidate the transacted ticket, and provide the information for regeneration to the client device. The client device applies the regeneration information to create a visual display representing a ticket. For example, a visual representation of a regenerated ticket may be constructed on the client device display; the display is presented at a point of entry to the event, scanned, and entry of the person bearing the client device is authorized into the event.

The system may transform one or more inputs from sensors and other sources to determine a price for a ticket and presents this price for single action selection on a user machine interface. The following are some factors that may affect the pricing of a ticket:

ticket pricing is influenced by current time relative to event time

ticket pricing is influenced by projected crowd and capacity

ticket pricing is influenced by recent transaction prices and trends; including velocity and acceleration of sales

ticket pricing is influenced by weather and other exogenous events (traffic, parking, availability of transit)

ticket pricing is influenced by ticket quality (e.g., ticket section, seat number)

ticket pricing is influenced by list price of ticket

ticket pricing is influenced by bid landscape for similar tickets

ticket pricing is influenced by ticket holder location

ticket pricing is influenced by ticket holder transaction history

ticket pricing is influenced by macroeconomic conditions

In one embodiment, the system accumulates demand signals from users interested in acquiring event tickets. The system produces and instant price and offer which is presented to the ticket holder. The ticket holder has the option to accept the offer via single action/interaction with their mobile device. If the ticket holder does not accept the offer, they may continue to receive future offers based on continuous monitoring of the market for their ticket by the system, leading to updated offers and alerts.

One embodiment of the system enables a process of competitive pricing for tickets to an upcoming event for which the time window is closing. The system may influence and present the price of tickets so that ticket holders can complete a ticket transfer with a single action. The presented prices are influenced by various factors in a unique way.

A set of sensors may output signals responsive to environmental factors. These may include weather conditions, crowd conditions, parking and transportation conditions, bid velocity and acceleration, and other factors.

The signals from the sensors are input to a signal transform module which performs transformations on the signals suitable for analysis by a pricing engine. Transformations vary according to the signal and the type of information is to be extracted from the signal. For example, transformations on weather station inputs produce values for analysis as to whether outdoor performances will be comfortable, of particular quality, or partially or totally disrupted. Transformation of images from cameras may identify masses of people and/or vehicles and change characteristics of those masses. The pricing engine communicates with a client device (e.g., a mobile device) to present a seller with a current price for their ticket and a machine interface for single-action transfer of their ticket into the system. The determination of price presented to the user of the client device is influenced by factors produced by signal transform module as determined by transformation the signals from the sensors. An ownership transfer module effects a transfer of ownership of a ticket to the system, from which it may be transferred to buyers/others, in response to a single user action on the machine interface of the client device indicating acceptance of the price for the ticket presented by the pricing engine.

Sensors utilized by some embodiments of the system may include one or more weather stations, cameras, clocks and GPS. GPS senses signals of wireless and electromagnetic nature from geo-synchronized satellites and indicative of geometric latitude and longitude coordinates on the earth's surface, as well as possibly indicative of altitude. GPS may thus sense locations of a ticket owner's client device, as well as locations of the devices of potential buyers/recipients of the ticket. The clock generates a periodic output signal in response to the behavior of an internal oscillator device. The periodic signal may be utilized to track a current time and window of time before an event to which a ticket applies. A weather metrics module produces weather metrics such as a comfort level based on signals from the weather station indicative of outdoor temperature, wind, barometric pressure, precipitation, fog, etc. A crowd estimator produces crowd estimates in response to signals input from the camera sensors. The crowd estimator may receive image or video signals from the camera sensors and may analyze these signals for lines, clusters, or distributions of people or vehicles at entries, gates, parking facilities, concessions, etc. and may further analyze changes to these structures over time for growth characteristics.

### DRAWINGS

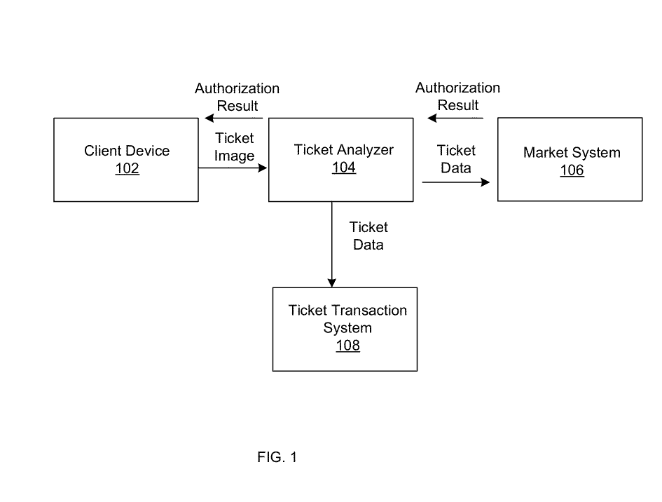

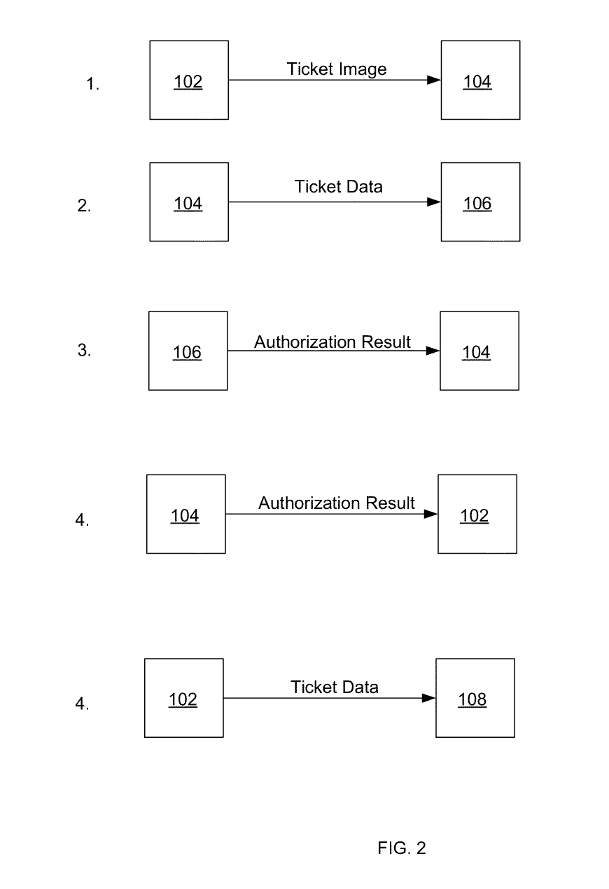

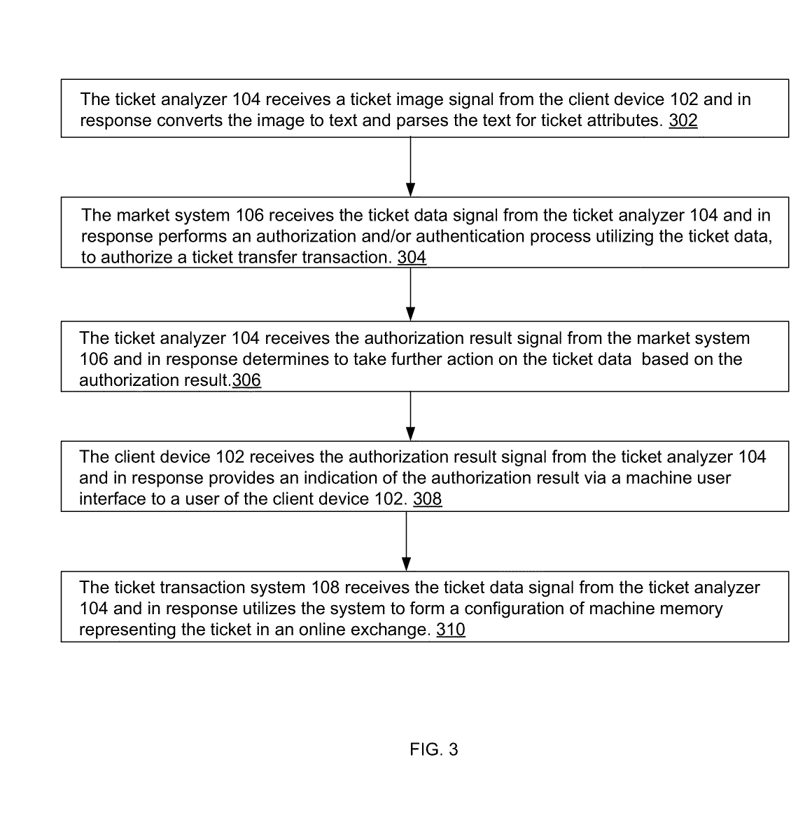

FIG. 1 is a system diagram of an embodiment of a ticket transaction and pricing system. FIG. 2 is an action flow diagram of an embodiment of a ticket transaction and pricing system. FIG. 3 is a flow chart of an embodiment of a ticket transaction and pricing system.

FIG. 1 illustrates the components of the system. The system comprises client device 102, ticket analyzer 104, market system 106, and ticket transaction system 108.

FIG. 2 and FIG. 3 illustrate an example operation of the system embodiment illustrated in FIG. 1. Together these drawings illustrate the ingest by the system of a ticket for ownership transfer. The client device 102 communicates a ticket image signal to the ticket analyzer 104. The ticket analyzer 104 receives the ticket image signal from the client device 102 and in response converts the image to text and parses the text for ticket attributes (302). The ticket analyzer 104 communicates a ticket data signal to the market system 106. The market system 106 receives the ticket data signal from the ticket analyzer 104 and in response performs an authorization and/or authentication process utilizing the ticket data, to authorize a ticket transfer transaction (304). The market system 106 communicates an authorization result signal to the ticket analyzer 104. The ticket analyzer 104 receives the authorization result signal from the market system 106 and in response determines to take further action on the ticket data based on the authorization result (306). The ticket analyzer 104 communicates an authorization result signal to the client device 102. The client device 102 receives the authorization result signal from the ticket analyzer 104 and in response provides an indication of the authorization result via a machine user interface to a user of the client device 102 (308). The client device 102 communicates the ticket data signal to the ticket transaction system 108. The ticket transaction system 108 receives the ticket data signal from the ticket analyzer 104 and in response utilizes the system to form a configuration of machine memory representing the ticket in an online exchange (310).

The operation associated with these actions and transforms may then conclude, or may repeat, periodically or aperiodically.

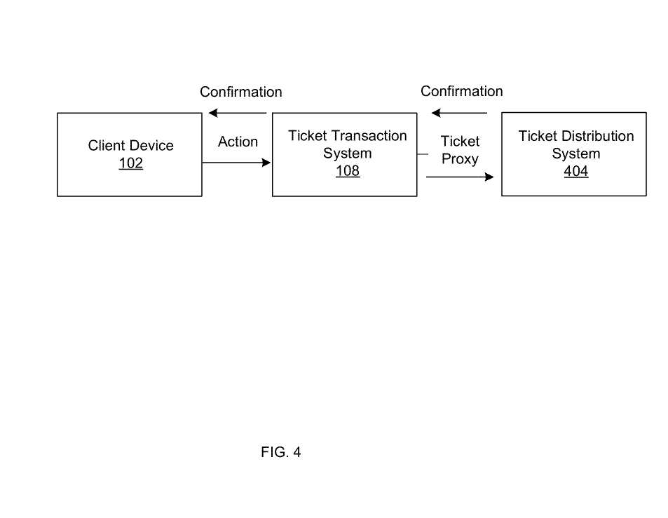

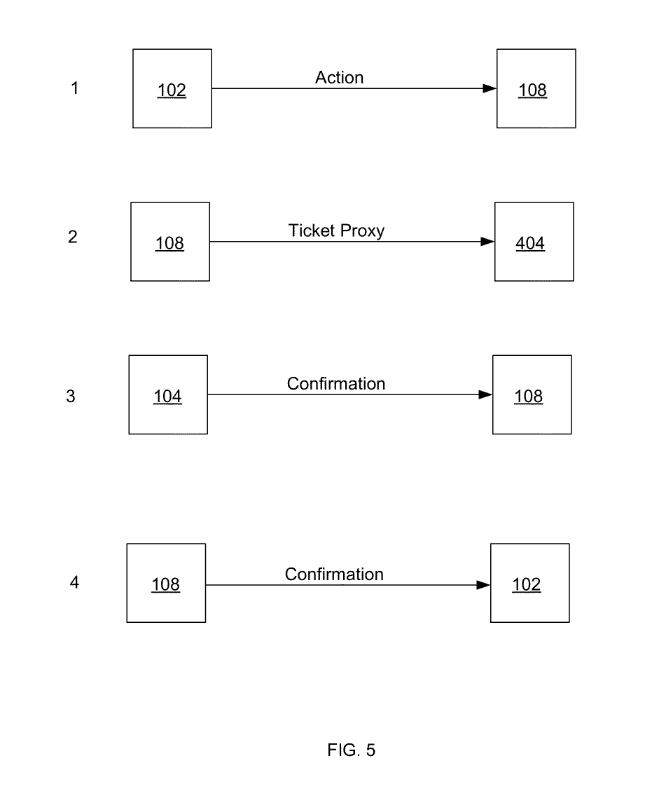

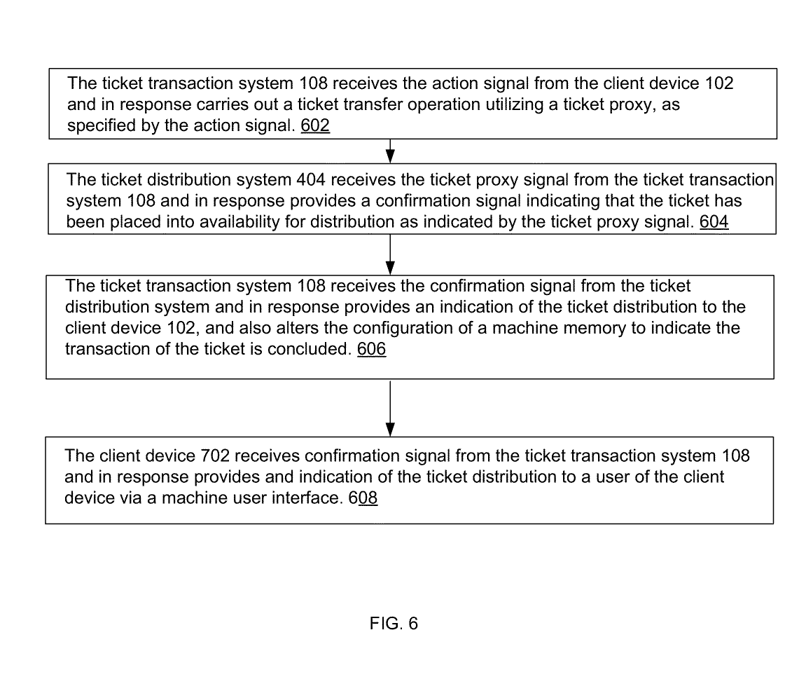

FIG. 4 is a system diagram of an embodiment of a ticket transaction and pricing system. FIG. 5 is an action flow diagram of an embodiment of a ticket transaction and pricing system. FIG. 6 is a flow chart of an embodiment of a ticket transaction and pricing system.

FIG. 4 illustrates the components of the system. The system comprises the client device 102, the ticket transaction system 108, and the ticket distribution system 404.

FIG. 5 and FIG. 6 illustrate an example operation of the system embodiment illustrated in FIG. 1. The client device 102 communicates an action signal to the ticket transaction system 108. The ticket transaction system 108 receives the action signal from the client device 102 and in response carries out a ticket transfer operation utilizing a ticket proxy, as specified by the action signal (602). The ticket transaction system 108 communicates a ticket proxy signal to the ticket distribution system 404. The ticket distribution system 404 receives the ticket proxy signal from the ticket transaction system 108 and in response provides a confirmation signal indicating that the ticket has been placed into availability for distribution as indicated by the ticket proxy signal (604). The client device 102 communicates a confirmation signal to the ticket transaction system 108. The ticket transaction system 108 receives the confirmation signal from the ticket distribution system and in response provides an indication of the ticket distribution to the client device 102, and also alters the configuration of a machine memory to indicate the transaction of the ticket is concluded (606). The ticket transaction system 109 communicates a confirmation signal to the client device 102. The client device 102 receives a confirmation signal from the ticket transaction system 108 and in response provides an indication of the ticket distribution to a user of the client device via a machine user interface (608).

The operation associated with these actions and transforms may then conclude, or may repeat, periodically or aperiodically.

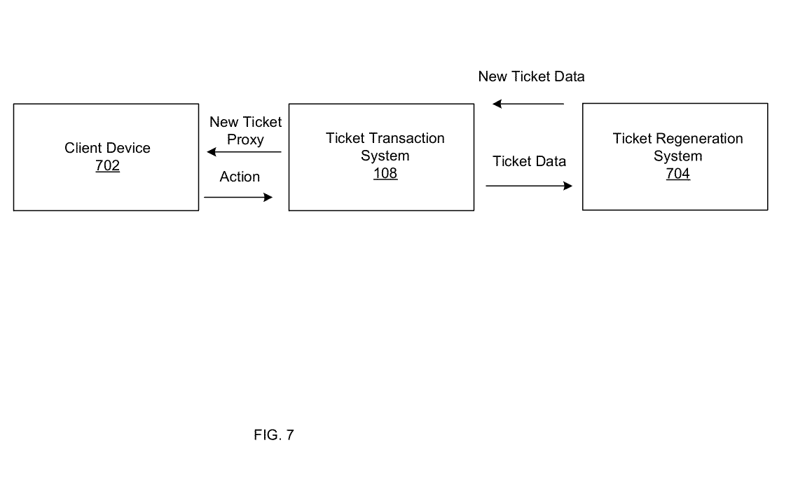

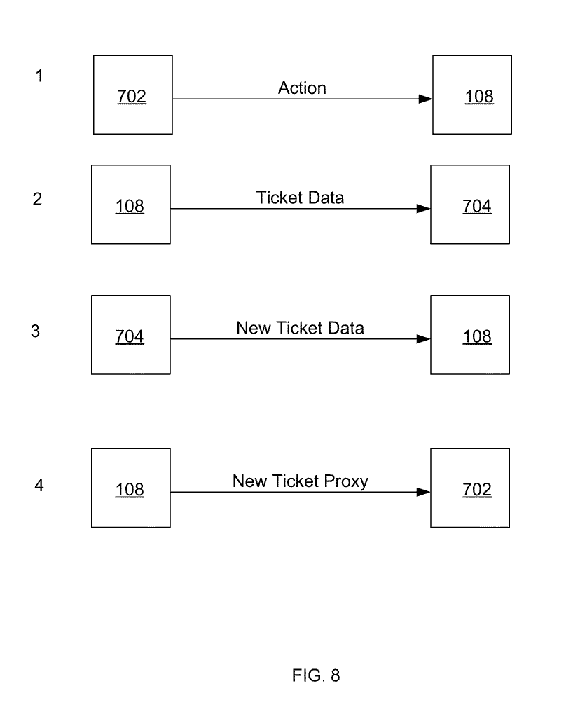

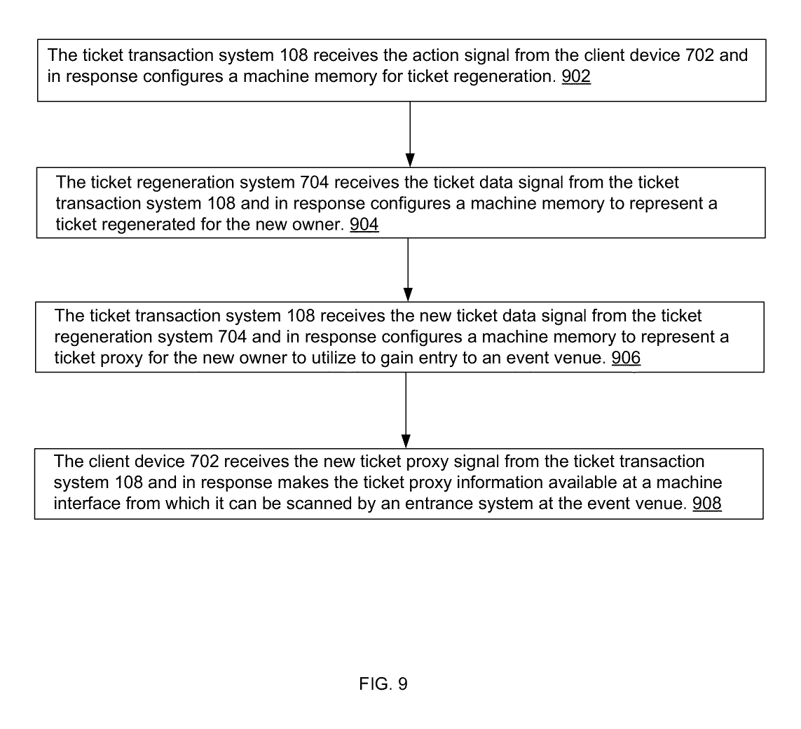

FIG. 7 is a system diagram of an embodiment of a ticket transaction and pricing system. FIG. 8 is an action flow diagram of an embodiment of a ticket transaction and pricing system. FIG. 9 is a flow chart of an embodiment of a ticket transaction and pricing system.

FIG. 7 illustrates the components of the system. The system comprises ticket transaction system 108, client device 702, and ticket regeneration system 704.

FIG. 8 and FIG. 9 illustrate an example operation of the system embodiment illustrated in FIG. 7. The client device 702 communicates an action signal to the ticket transaction system 108. The ticket transaction system 108 receives the action signal from the client device 702 and in response configures a machine memory for ticket regeneration (902). The ticket transaction system 108 communicates a ticket data signal to the ticket regeneration system 704. The ticket regeneration system 704 receives the ticket data signal from the ticket transaction system 108 and in response configures a machine memory to represent a ticket regenerated for the new owner (904). The ticket regeneration system 704 communicates a new ticket data signal to the ticket transaction system 108. The ticket transaction system 108 receives the new ticket data signal from the ticket regeneration system 704 and in response configures a machine memory to represent a ticket proxy for the new owner to utilize to gain entry to an event venue (906). The ticket transaction system 108 communicates a new ticket proxy signal to the client device 702. The client device 702 receives the new ticket proxy signal from the ticket transaction system 108 and in response makes the ticket proxy information available at a machine interface from which it can be scanned by an entrance system at the event venue (908).

The operation associated with these actions and transforms may then conclude, or may repeat, periodically or aperiodically.

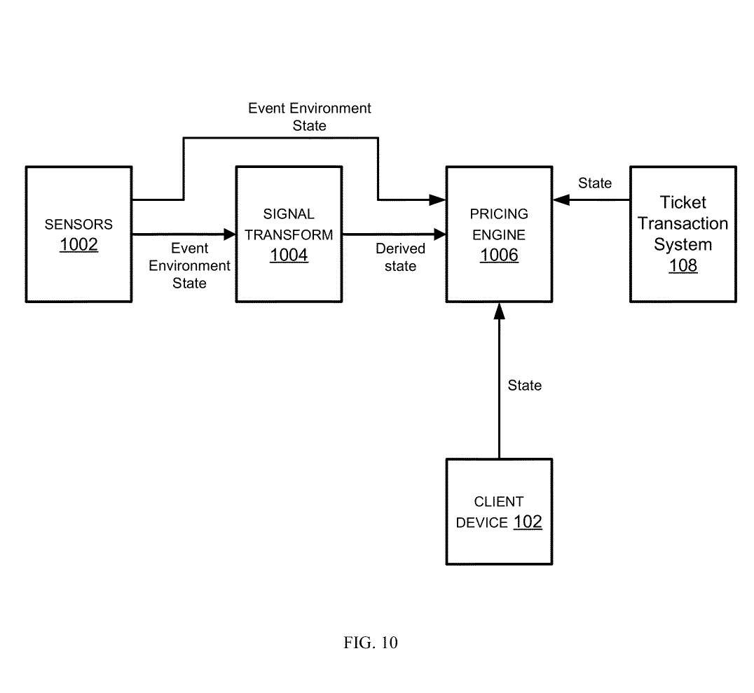

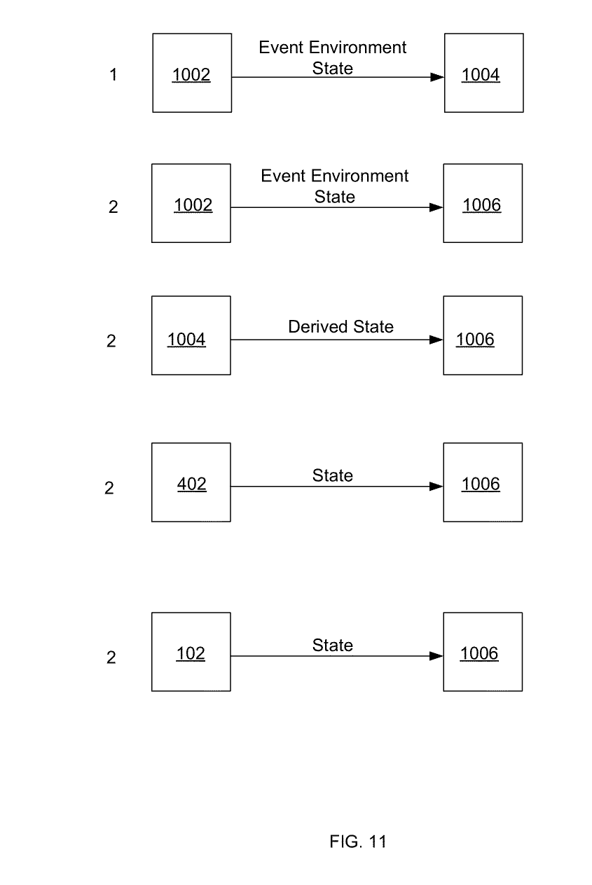

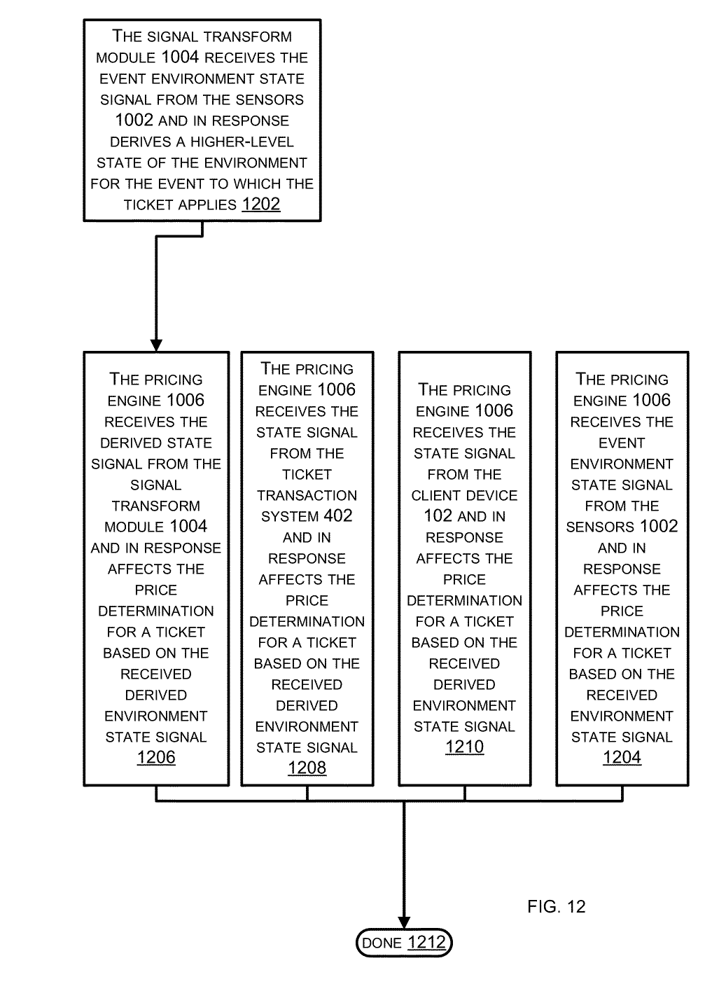

FIG. 10 is a system diagram of an embodiment of a ticket transaction and pricing system. FIG. 11 is an action flow diagram of an embodiment of a ticket transaction and pricing system. FIG. 12 is a flow chart of an embodiment of a ticket transaction and pricing system.

FIG. 10 illustrates the components of the system. The system comprises client device 102, ticket transaction system 108, sensors 1002, signal transform 1004, and pricing engine 1006.

FIG. 11 and FIG. 12 illustrate an example operation of the system embodiment illustrated in FIG. 10. The sensors 1002 communicate an event environment state signal to the signal transform 1004. The signal transform module 1004 receives the event environment state signal from the sensors 1002 and in response derives a higher-level state of the environment for the event to which the ticket applies (1202). The sensors 1002 communicate an event environment state to the pricing engine 1006. The pricing engine 1006 receives the event environment state signal from the sensors 1002 and in response affects the price determination for a ticket based on the received environment state signal (1204). The signal transform module 1004 communicates a derived state signal to the pricing engine 1006. The pricing engine 1006 receives the derived state signal from the signal transform module 1004 and in response affects the price determination for a ticket based on the received derived environment state signal (1206). The ticket transaction system 402 communicates a state signal to the pricing engine. The pricing engine 1006 receives the state signal from the ticket transaction system 402 and in response affects the price determination for a ticket based on the received derived environment state signal (1208). The client device 102 communicates a state signal to the pricing engine 1006. The pricing engine 1006 receives the state signal from the client device 102 and in response affects the price determination for a ticket based on the received derived environment state signal (1210).

At 1212 the process concludes.

The operation associated with these actions and transforms may then conclude, or may repeat, periodically or aperiodically.

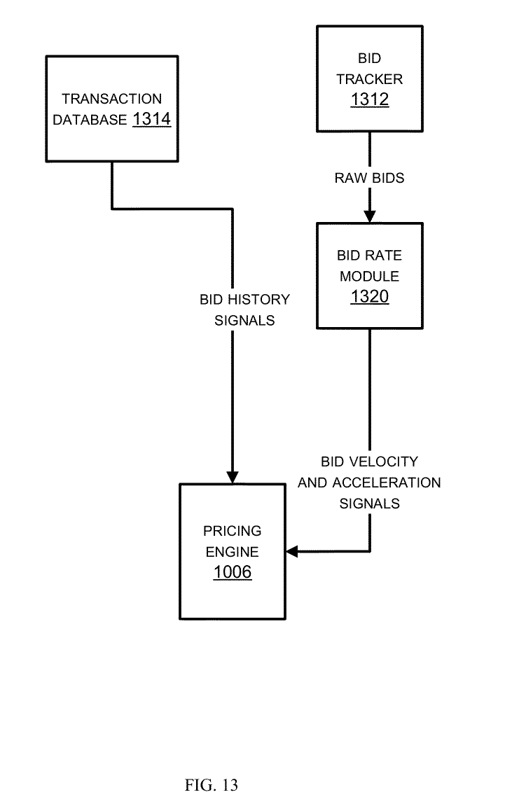

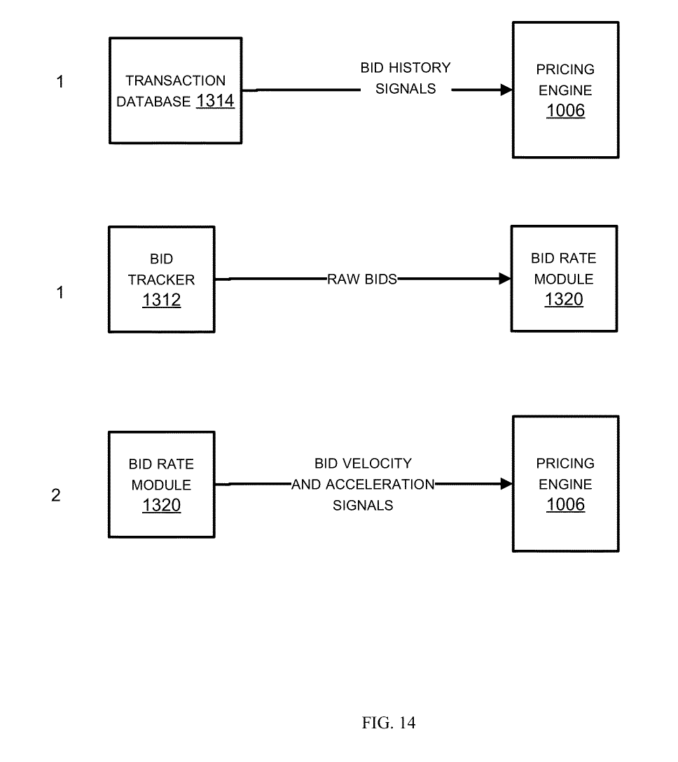

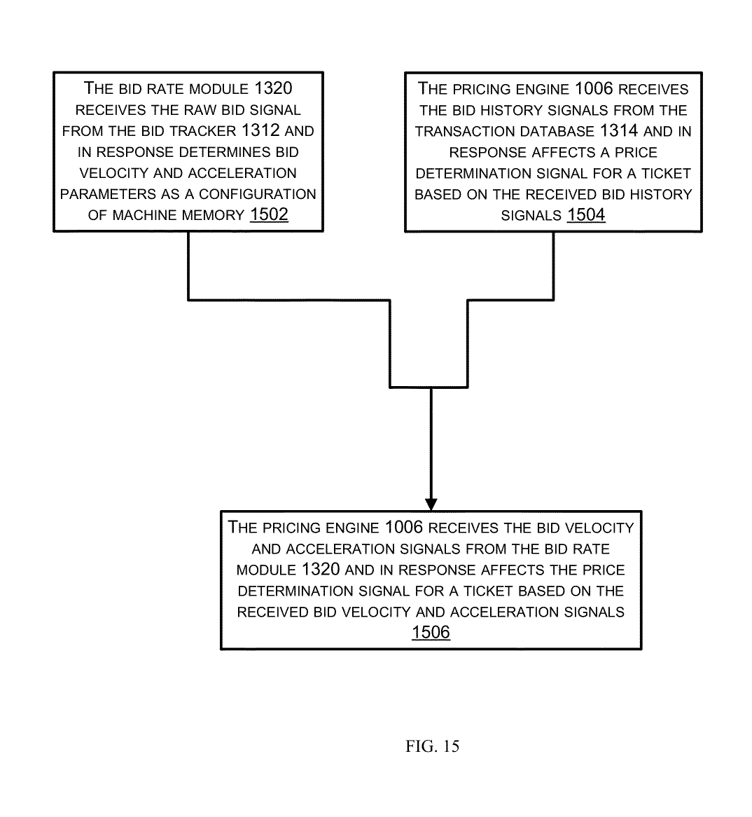

FIG. 13 is a system diagram of an embodiment of a ticket transaction and pricing system. FIG. 14 is an action flow diagram of an embodiment of a ticket transaction and pricing system. FIG. 15 is a flow chart of an embodiment of a ticket transaction and pricing system.

FIG. 13 illustrates the components of the system. The system comprises pricing engine 1006, bid tracker 1312, transaction 1314, and bid rate module 1320.

FIG. 14 and FIG. 15 illustrate an example operation of the system embodiment illustrated in FIG. 13. The transaction database 1314 communicates bid history signals to the pricing engine 1006. The pricing engine 1006 receives the bid history signals from the transaction database 1314 and in response affects a price determination signal for a ticket based on the received bid history signals (1504). The bid tracker 1312 communicates a raw bids signal to the bid rate module 1320. The bid rate module 1320 receives the raw bid signal from the bid tracker 1312 and in response determines bid velocity and acceleration parameters as a configuration of machine memory (1502). The bid rate module 1320 communicates bid velocity and acceleration signals to the pricing engine 1006. The pricing engine 1006 receives the bid velocity and acceleration signals from the bid rate module 1320 and in response affects the price determination signal for a ticket based on the received bid velocity and acceleration signals (1506).

The operation associated with these actions and transforms may then conclude, or may repeat, periodically or aperiodically.

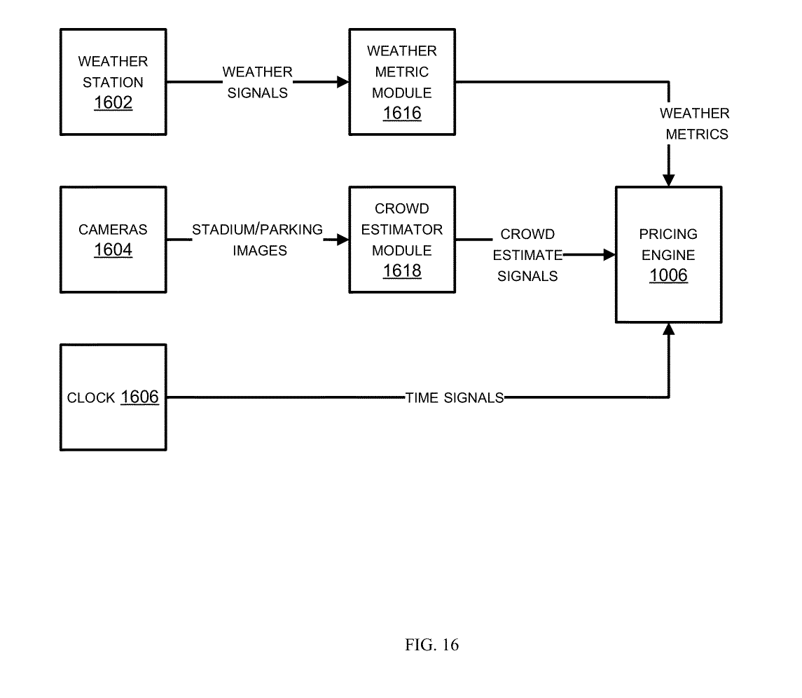

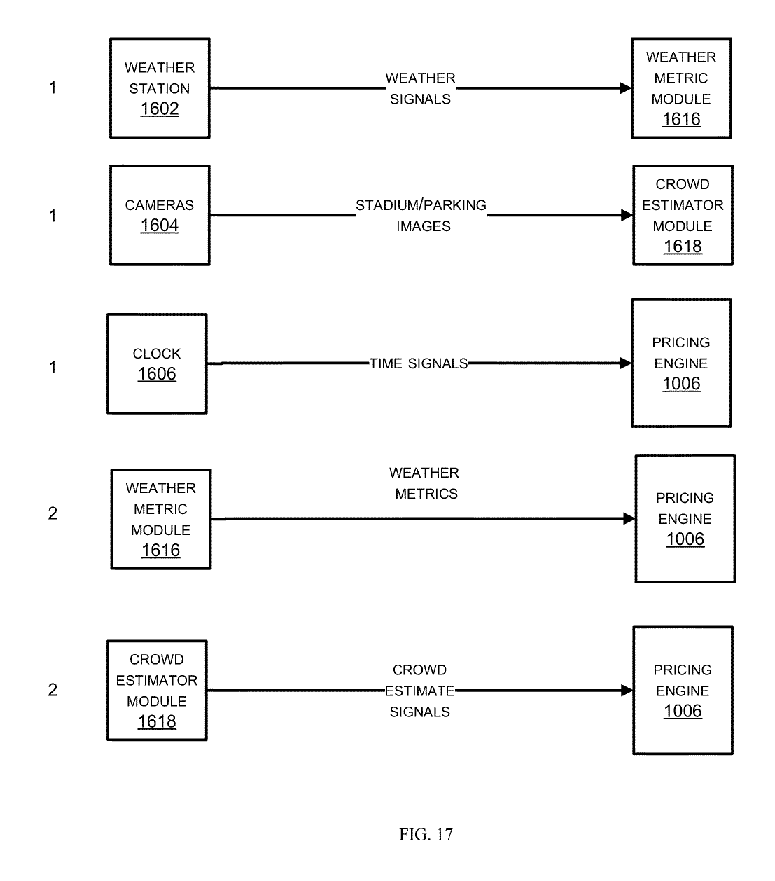

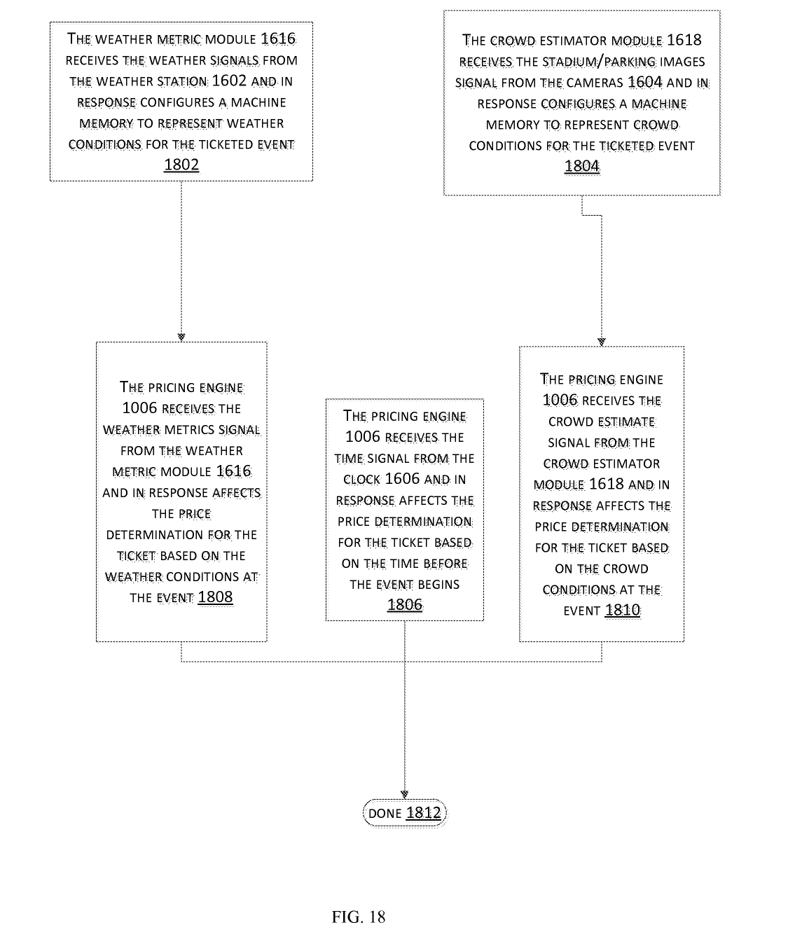

FIG. 16 is a system diagram of an embodiment of a ticket transaction and pricing system. FIG. 17 is an action flow diagram of an embodiment of a ticket transaction and pricing system. FIG. 18 is a flow chart of an embodiment of a ticket transaction and pricing system.

FIG. 16 illustrates the components of the system. The system comprises of a pricing engine 1006, weather station 1602, cameras 1604, clock 1606, weather metric module 1616, and crowd estimator module 1618.

FIG. 17 and FIG. 18 illustrate an example operation of the system embodiment illustrated in FIG. 16. The weather station 1602 communicates weather signals to the weather metric module 1616. The weather metric module 1616 receives the weather signals from the weather station 1602 and in response configures a machine memory to represent weather conditions for the ticketed event (1802). The cameras 1604 communicate a stadium/parking images signal to the crowd estimator module 1618. The crowd estimator module 1618 receives the stadium/parking images signal from the cameras 1604 and in response configures a machine memory to represent crowd conditions for the ticketed event (1804). The clock 1606 communicates time signals to the pricing engine 1006. The pricing engine 1006 receives the time signal from the clock 1606 and in response affects the price determination for the ticket based on the time before the event begins (1806). The weather metric module 1616 communicates weather metrics signal to the pricing engine 1006. The pricing engine 1006 receives the weather metrics signal from the weather metric module 1616 and in response affects the price determination for the ticket based on the weather conditions at the event (1808). The crowd estimator module 1618 communicates crowd estimate signals to the pricing engine 1006. The pricing engine 1006 receives the crowd estimate signal from the crowd estimator module 1618 and in response affects the price determination for the ticket based on the crowd conditions at the event (1810).

At 1812 the process concludes.

The operation associated with these actions and transforms may then conclude, or may repeat, periodically or aperiodically.

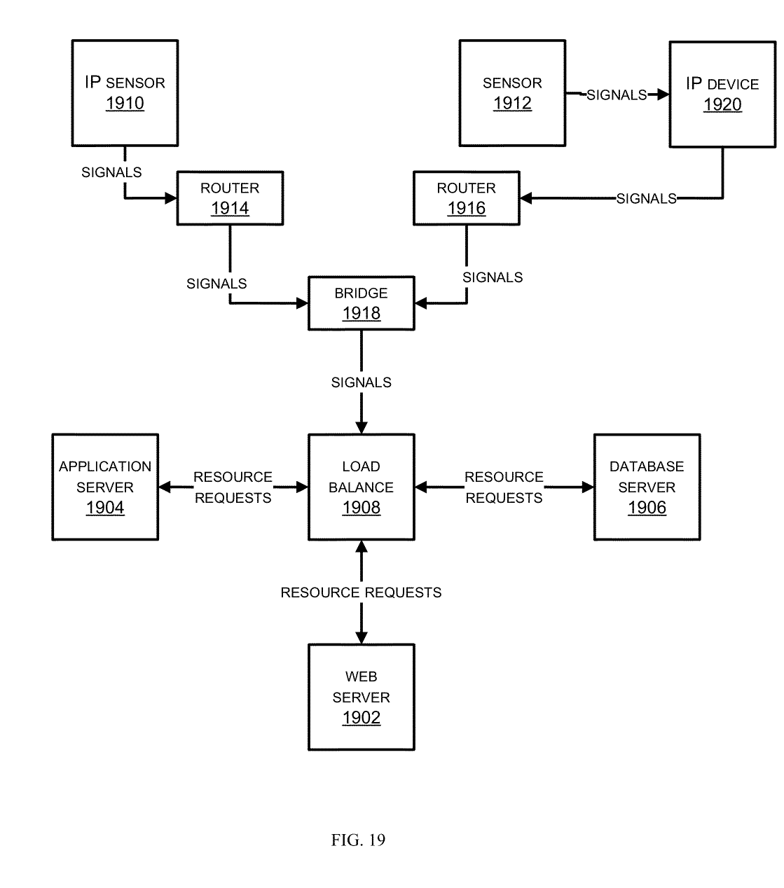

FIG. 19 illustrates an embodiment a machine system to implement a ticket pricing system. An IP sensor 1910 responds to a physical stimulus from the environment with output signals that represent the physical stimulus. The signal is output in Internet Protocol (IP) format (for example), and propagated via a router 1914 and a bridge 1918 to a server system. Another sensor 1912 does not have IP protocol capability and so outputs signals in a different (e.g., analog or non-IP digital) format to an IP-enabled device 1920 which converts the signals output by the sensor 1912 into an IP protocol and communicates them via a router 1916 and bridge 1918 to the server system. The server system inn this example comprises a number of separate server devices, typically each implemented in the separated machine, although this is not necessarily the case. The signals from the sensors are provided via a load balancing server 1908 to one or more application server 1904 and one or more database server 1916. Load balancing server 1908 maintains an even load distribution to the other server, including web server 1902, application server 1904, and database server 1906. In one implementation of a ticket pricing system, the application server 1904 may implement a ticket pricing engine and the database server 1906 may implement a bid history server. Each server in the drawing may represent in effect multiple servers of that type. The signals applied to the database server 1906 may cause the database server 1906 to access and certain memory addresses, which correlates to certain rows and columns in a memory device. These signals from the database server 1906 may also be applied to application server 1904 via the load balancing server 1908. The system may supply signals to the web server 1902, which in turn converts the signals to resources (e.g., marketplace signals for a ticket price) available via the Internet or other WAN by devices of users of the system (client devices).

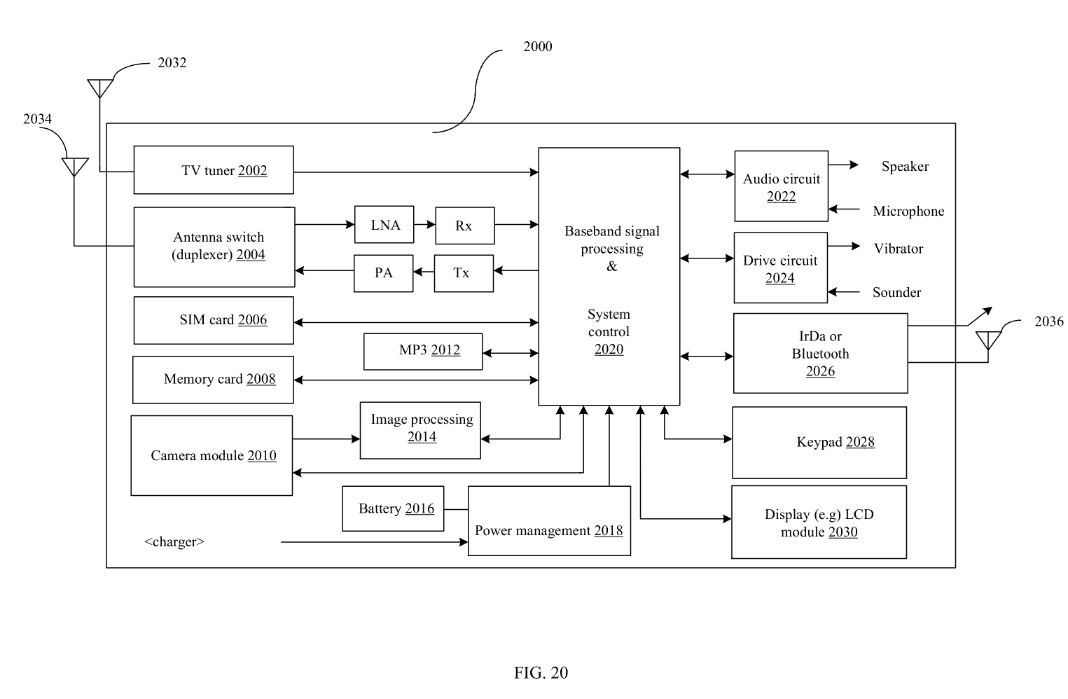

FIG. 20 illustrates an embodiment of a mobile device 2000 that may implement a machine having features described herein, for example a client device. Logic 2020 provides device system control over other components and coordination between those components as well as signal processing for the device. Signal processing extracts baseband signals from the radio frequency signals received by the device, and processes baseband signals up to radio frequency signals for communications transmitted from the device. Logic 2020 may comprise a central processing unit, digital signal processor, and/or one or more controllers or combinations above these components. The device may further comprise memory card 2008 which may be utilized to add and remove machine memory for use by the central processors, digital signal processors in controllers of the systems logic 2020.

Radio frequency signals are received and transmitted by the device using an antenna 2034 coupled to antenna switch 2004. Received signals may be communicated from the antenna switch 2004 through a low noise amplifier to the logic 2020. Signals for transmission from logic 2020 may be communicated to a power amplifier and from there to antenna switch 2004 for transmission through the antenna 2034.

A subscriber identity module (SIM) card 2006 may be present in some mobile devices, especially those operated on the Global System for Mobile Communication (GSM) network. The SIM card 2006 stores, in machine-readable memory, personal information of a mobile service subscriber, such as the subscriber's cell phone number, address book, text messages, and other personal data. A user of the device can move the SIM card to a different mobile device 2000 and maintain access to their personal information. A SIM card typically has a unique number which identifies the subscriber to the wireless network service provider.

A camera module 2010 may interface to a camera device to capture images and video from the environment. These images and video may be provided to an image processing module 2014 for enhancement, compression, and other processing, and from there to the central control logic 420 for further processing and storage to memory 2008. Images, video and other display information, for example, user interface optical patterns, may be output to a display module 2030 which may for example operate as a liquid crystal display or may utilize other optical output technology. The display module 2030 may also operate as a user input device, being touch sensitive where contact or close contact by a use's finger or other device handled by the user may be detected by transducers. An area of contact or proximity to the display module 2030 may also be detected by transducers and this information may be supplied to the control logic 2020 to affect the internal operation of the mobile device 2000 and to influence control and operation of its various components.

The mobile device 2000 may include an MP3 decoder 2012 for decoding digital music files or audio files stored on memory card 2008 or received in real time via antenna 2034. The MP3 decoder 2012 is operated by the logic 2020 and decoded audio is provided to an audio circuit 2022 from which is output to one and more speakers to create pressure waves in the external environment representing the encoded audio in the MP3 file or stream.

The mobile device 2000 may operate on power received from a battery 2016. The battery capability and energy supply may be managed by a power management module 2018.

Another user interface device operated by control logic 2020 is a keypad 2028 which responds to pressure or contact events by a user of the device. As noted the keypad may in some cases be implemented by transducers of the display module 2030.

The mobile device 2000 may generate short range wireless signals to influence other devices in its proximity, and may receive wireless signals from those proximate devices using antenna 2036. Short range radio signals may influence the device, or be generated by the device for output to the environment, through a BlueTooth or WiFi module 2026. Other forms of electromagnetic radiation may be used to interact with proximate devices, such as IRDA (infrared signals). The device may utilize a haptic drive circuit 2024 which provides vibrations in response to events identified by control logic 2020, such as the received text messages, emails, incoming calls or other events that require the user or the device's attention.

The mobile device 2000 may convert audio phenomenon from the environment into internal electro or optical signals by using microphone and the audio module 2022. The mobile device 2000 may receive television signals using a TV tuner 2002 coupled to a television antenna 2032.

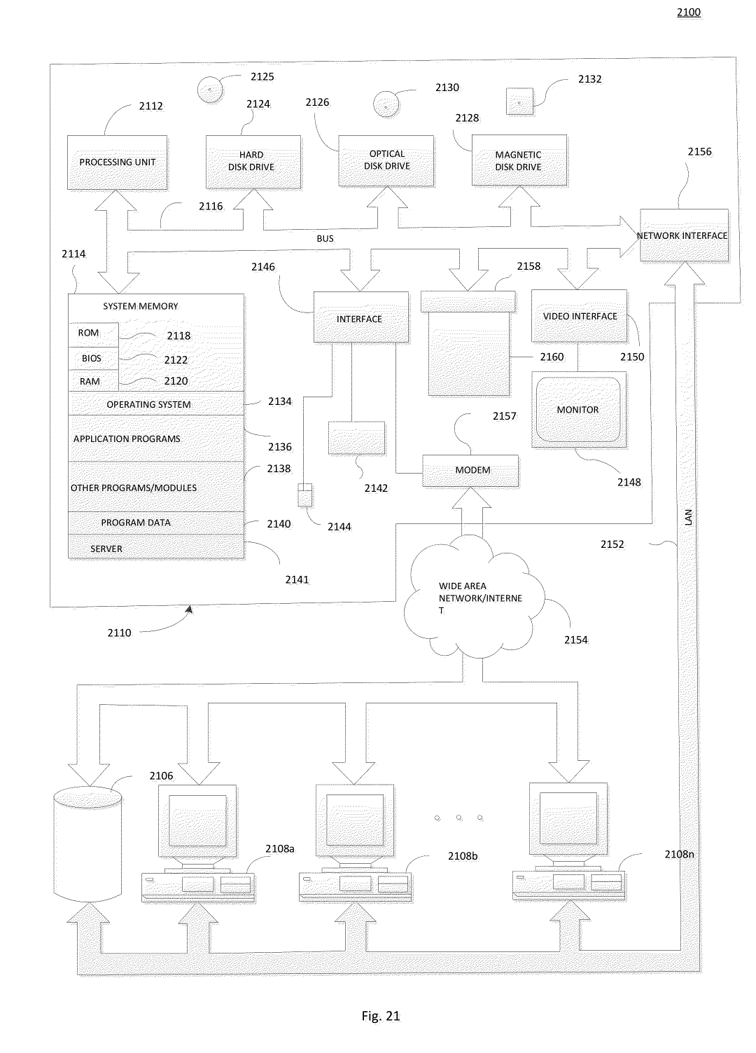

FIG. 21 illustrates an embodiment of a computer system machine and a machine communication network. The computer system 2100 may implement an embodiment of one or more of the server devices described herein. A particular computer system 2100 of the machine network may include one or more processing units 2112a, 2112b (collectively 2112), a system memory 2114 and a system bus 2116 that couples various system components including the system memory 2114 to the processing units 2112. The processing units 2112 may be any logic processing unit, such as one or more central processing units (CPUs) 2112a, digital signal processors (DSPs) 2112b, application-specific integrated circuits (ASICs), field programmable gate arrays (FPGAs), etc. The system bus 2116 can employ any known bus structures or architectures, including a memory bus with memory controller, a peripheral bus, and a local bus. The system memory 2114 includes read-only memory (ROM) 2118 and random access memory (RAM) 2120. A basic input/output system (BIOS) 2122, which can form part of the ROM 2118, contains basic routines that help transfer information between elements within the computer system 2100, such as during start-up.

The computer system 2100 may also include a plurality of interfaces such as network interface 2160, interface 2150 supporting modem 2162 or any other wireless/wired interfaces.

The computer system 2100 may include a hard disk drive 2124 for reading from and writing to a hard disk 2126, an optical disk drive 2128 for reading from and writing to removable optical disks 2132, and/or a magnetic disk drive 2130 for reading from and writing to magnetic disks 2134. The optical disk 2132 can be a CD-ROM, while the magnetic disk 2134 can be a magnetic floppy disk or diskette. The hard disk drive 2124, optical disk drive 2128 and magnetic disk drive 2130 may communicate with the processing unit 2112 via the system bus 2116. The hard disk drive 2124, optical disk drive 2128 and magnetic disk drive 2130 may include interfaces or controllers (not shown) coupled between such drives and the system bus 2116, as is known by those skilled in the relevant art. The drives 2124, 2128 and 230, and their associated computer-readable storage media 2126, 2132, 2134, may provide non-volatile and non-transitory storage of computer readable instructions, data structures, program modules and other data for the computer system 2100. Although the depicted computer system 2100 is illustrated employing a hard disk 2124, optical disk 2128 and magnetic disk 2130, those skilled in the relevant art will appreciate that other types of computer-readable storage media that can store data accessible by a computer may be employed, such as magnetic cassettes, flash memory, digital video disks (DVD), Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, compact disc ROM (CD-ROM), digital versatile disks (DVD) or other optical disk storage, magnetic cassettes, magnetic tape, magnetic disk storage or other magnetic storage devices, solid state memory or any other medium which can be used to store the desired information and which may be accessed by processing unit 2112a.

Program modules can be stored in the system memory 2114, such as an operating system 2136, one or more application programs 2138, other programs or modules 2140 and program data 2142. Application programs 2138 may include instructions that cause the processor(s) 2112 to automatically provide dynamic selection of data and telecommunication service providers before or during communications between various devices such as, for example, a mobile device and a landline telephone. Other program modules 2140 may include instructions for handling security such as password or other access protection and communications encryption. The system memory 2114 may also include communications programs, for example, a Web client or browser 2144 for permitting the computer system 2100 to access and exchange data with sources such as Web sites of the Internet, corporate intranets, extranets, or other networks and devices as described herein, as well as other server applications on server computing systems. The browser 2144 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft.

Although illustrated as being stored in the system memory 2114, the operating system 2136, application programs 2138, other programs/modules 2140, program data 2142 and browser 2144 can be stored on the hard disk 2126 of the hard disk drive 2124, the optical disk 2132 of the optical disk drive 2128 and/or the magnetic disk 2134 of the magnetic disk drive 2130.

An operator can enter commands and information into the computer system 2100 through input devices such as a touch screen or keyboard 2146 and/or a pointing device such as a mouse 2148, and/or via a graphical user interface. Other input devices can include a microphone, joystick, game pad, tablet, scanner, etc. These and other input devices are connected to one or more of the processing units 2112 through an interface 2150 such as a serial port interface that couples to the system bus 2116, although other interfaces such as a parallel port, a game port or a wireless interface or a universal serial bus (USB) can be used. A monitor 2152 or other display device is coupled to the system bus 2116 via a video interface 254, such as a video adapter. The computer system 2100 can include other output devices, such as speakers, printers, etc.

The computer system 2100 can operate in a networked environment using logical connections to one or more remote computers and/or devices. For example, the computer system 2100 can operate in a networked environment using logical connections to one or more mobile devices, landline telephones and other service providers or information servers. Communications may be via a wired and/or wireless network architecture, for instance wired and wireless enterprise-wide computer networks, intranets, extranets, telecommunications networks, cellular networks, paging networks, and other mobile networks.

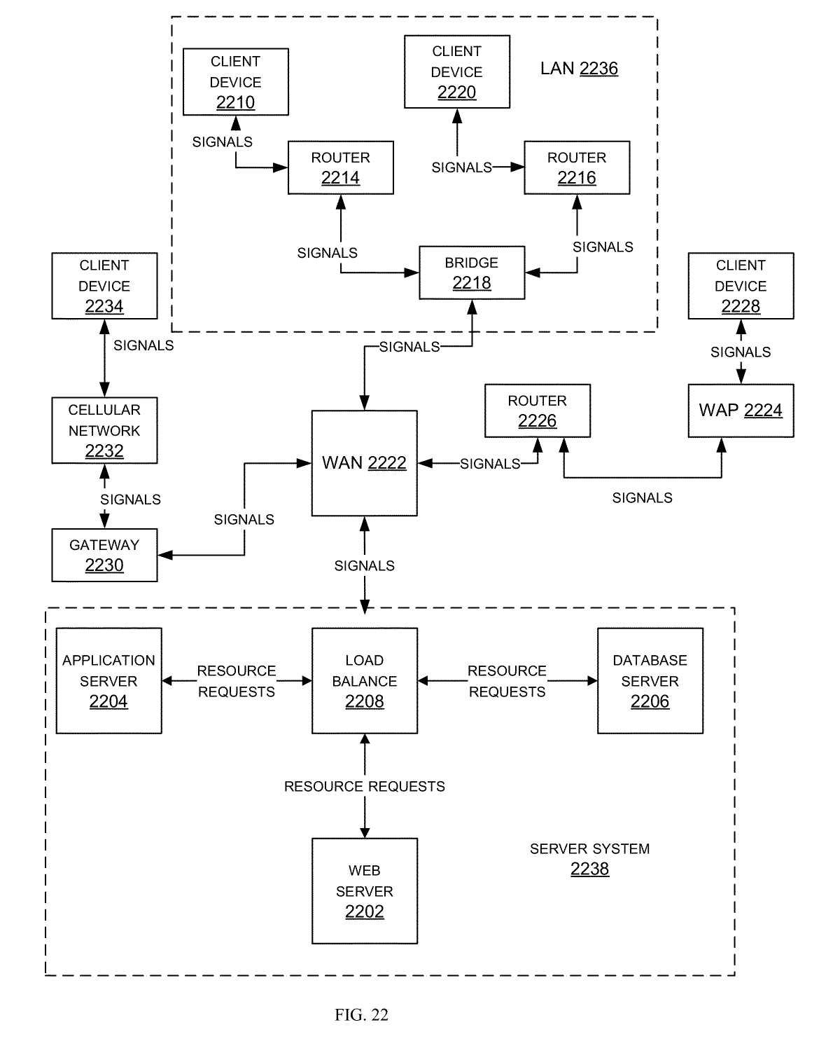

A ticket transaction and pricing system as described herein may be implemented in one embodiment by the machine system illustrated in FIG. 22. Several network access technologies between client devices and server resources are illustrated, including cellular network 2232, LAN 2236, and WAP 2224. Signals representing server resource requests are output from client devices 2210, 2220, 2228, and 2234 to the various access networks, from which they are propagated to a WAN 2222 (e.g., the Internet) and from there to a server system. These signals are typically encoded into standard protocols such as Internet Protocol (IP), TCP/IP, and HTTP. When the clients are part of a LAN 2236, the signals may be propagated via one or more router 2214 2216 and a bridge 2218. A router 2226 may propagate signals from the WAP 2224 to the WAN 2222. A gateway 2230 may propagate signals from the cellular network 2232 to the WAN 2222. The server system in this example comprises a number of separate server devices, typically each implemented in the separated machine, although this is not necessarily the case. The signals from the client devices are provided via a load balancing server 2208 to one or more application server 2204 and one or more database server 2216. Load balancing server 2208 maintains an even load distribution to the other server, including web server 2202, application server 2204, and database server 2206. Each server in the drawing may represent in effect multiple servers of that type. The load balancing server 2208, application server 2204, and database server 2206 may collectively implement a ticket transaction and pricing system as described herein. The signals applied to the database server 2206 may cause the database server 2206 to access and certain memory addresses, which correlates to certain rows and columns in a memory device. These signals from the database server 2206 may also be applied to application server 2204 via the load balancing server 2208. Signals applied by the application server 2204, via the load balancing server 2208, to the web server 2202, may result in web page modifications which are in turn communicated to a client device, as described herein in regards to user interface and interaction signals to and from a client device. The ticket pricing and transaction system described herein may thus be implemented as devices coordinated on a LAN, or over a wide geographical area utilizing a WAN or cellular network, or over a limited area (room or house or store/bar) utilizing a WAP. Features of client logic to store and communicate ticket information (e.g., images of tickets) may thus be implemented, for example, as an application (app) on a mobile phone interfacing to a network in one of the manners illustrated in this figure. The ticket pricing and transaction system described herein may be implemented as a pure or hybrid peer to peer system in a local or widely distributed area.

Implementations and Alternatives

The techniques and procedures described herein may be implemented via logic distributed in one or more computing devices. The particular distribution and choice of logic is a design decision that will vary according to implementation.

Those having skill in the art will appreciate that there are various logic implementations by which processes and/or systems described herein can be effected (e.g., hardware, software, and/or firmware), and that the preferred vehicle will vary with the context in which the processes are deployed. “Software” refers to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory.

In a general sense, those skilled in the art will recognize that the various aspects described herein which can be implemented, individually and/or collectively, by a wide range of hardware, software, firmware, or any combination thereof can be viewed as being composed of various types of “circuitry.” Consequently, as used herein “circuitry” includes, but is not limited to, electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), circuitry forming a memory device (e.g., forms of random access memory), and/or circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A ticket transfer system, comprising:
a ticket analyzer system comprising logic adapted to receive an image of a ticket to an event;
the ticket analyzer system comprising logic adapted to extract information about the ticket from the image;
the ticket analyzer comprising logic adapted to apply the extracted information to identify a primary market system for the ticket and to verify validity of the ticket with the primary market system; and
the ticket analyzer system comprising logic adapted to apply received signals on weather, time, or crowd conditions for the event to affect a price displayed for the ticket on an online exchange.

2. The ticket transfer system of claim 1, further comprising:
logic adapted to apply received signals identifying locations of client devices of identified potential buyers of the ticket to affect the price displayed for the ticket.

3. The ticket transfer system of claim 1, further comprising:
logic adapted to apply received signals on bidding history for tickets having similar properties as the ticket to affect the displayed price.

4. The ticket transfer system of claim 1, further comprising:
logic adapted to apply received signals on bid velocity or bid acceleration for the ticket to the displayed price.

5. The ticket transfer system of claim 1, further comprising:
logic to communicate signals defining a regenerated version of the ticket to a client device of a purchaser of the ticket.

6. A ticket transfer process, comprising:
receiving an image of a ticket to an event;
applying machine analysis to the pixels of the image to extract information about the ticket from the image;
applying the extracted information to identify a primary market system for the ticket and to verify validity of the ticket with the primary market system; and
applying received signals from sensors on weather, time, or crowd conditions for the event to affect a price displayed for the ticket on an online exchange.

7. The ticket transfer process of claim 6, further comprising:
applying signals identifying the location of client devices of identified potential buyers of the ticket to affect the price displayed for the ticket.

8. The ticket transfer process of claim 6, further comprising:
applying received signals on bidding history for tickets having similar properties as the ticket to the displayed price.

9. The ticket transfer process of claim 6, further comprising:
applying received signals on bid velocity or bid acceleration for the ticket to the displayed price.

10. The ticket transfer process of claim 6, further comprising:
communicating signals defining a regenerated version of the ticket to a client device of a purchaser of the ticket.
